(19) United States
(12) Patent Application Publication
(10) Pub. No.: US 2013/0276530 A1
(43) Pub. Date: Oct. 24, 2013

(54) WATER LEVEL MEASURING SYSTEM AND NON-CONDENSABLE GAS DISCHARGE DEVICE FOR SAME

(71) Applicants: Seiji Kanasaki, Tokyo (JP); Kei Sato, Kanagawa (JP)

(72) Inventors: Seiji Kanasaki, Tokyo (JP); Kei Sato, Kanagawa (JP)

(73) Assignee: KABUSHIKI KAISHA TOSHIBA

(21) Appl. No.: 13/978,580

(22) PCT Filed: Jan. 11, 2012
(86) PCT No.: PCT/JP2012/000110

§ 371 Date: Jul. 8, 2013

(30) Foreign Application Priority Data
Jan. 11, 2011 (JP) 2011-003128

(51) Int. Cl. G01F 23/16

(52) U.S. Cl. CPC G01F 23/16
USPC 73/290 R

(57) ABSTRACT

A water level measuring system (10) has: a riser piping section (3) connected to a plant device (20) and extending to above the plant device (20); an upper piping section (4) connected to the riser piping section (3); a connection piping section (5) having an upper end connected to the upper piping section (4) and extending downward; a lower instrumentation piping (2b) connected to the plant device (20); a water level gauge (1) provided with a first connection section (31) which is connected to the lower end of the connection piping section (5) and also with a second connection section (32) which is connected to the lower instrumentation piping (2b), the water level gauge (1) measuring the differential pressure between the first connection section (31) and the second connection section (32); a vent pipe (12) branched from the connection piping section (5); a control valve (11) installed in the vent pipe (12); and hydrogen concentration detectors (6) mounted to the riser piping section (3), the upper piping section (4), and the connection piping section (5).

### TECHNICAL FIELD

Embodiments of the present invention relate to a water level measuring system provided in a plant device such as a feed water heater and the like, and a non-condensable gas discharge device thereof.

### BACKGROUND ART

Generally, a plant device such as a feed water heater or a drain tank in a nuclear power plant is provided with a water level measuring equipment, in order to monitor, a water level in the device. In such a water level measuring equipment, when non-condensable gas accumulates and remains in an instrumentation piping, a measurement error increases. In view of this, discharging means for the non-condensable gas is provided in the instrumentation piping so as to prevent the non-condensable gas from being accumulated and retained in the instrumentation piping. A conventional non-condensable gas discharge device is described with reference to FIG. 3 (Patent Document 1).

In order to heat nuclear-reactor feed water, turbine extraction steam is supplied to a feed water heater 20 through a turbine extraction steam pipe 21, and drain of the turbine extraction steam which has heated nuclear reactor feed water and has been condensed is discharged outside from a drain pipe (not illustrated) provided at a bottom part of the feed water heater 20. The turbine extraction steam includes non-condensable gas such as hydrogen gas and oxygen gas, and after this non-condensable gas is retained temporarily in a gas phase part in the feed water heater 20, the non-condensable gas is discharged outside from a vent line 22.

A water level measuring system 10 includes an upper instrumentation piping 2a pulled out upward from an upper part of the feed water heater 20 and connected to a water level gauge 1, and a lower instrumentation piping 2b pulled out downward from a lower part of the feed water heater 20 and connected to the water level gauge 1.

Further, since the non-condensable gas in the feed water heater 20 is mixed into this upper instrumentation piping 2a, a vent pipe 12 is connected to the upper instrumentation piping 2a for water-level measurement, so that the non-condensable gas accumulated and retained in the upper instrumentation piping 2a is discharged to the vent pipe 12.

### PRIOR ART DOCUMENT

### Patent Document

Patent Document 1: Japanese Patent Application Laid-Open No. 2004-20497

### SUMMARY OF THE INVENTION

### Problems to be Solved by the Invention

In the aforementioned non-condensable gas discharge device, since discharge flow of the non-condensable gas regularly occurs in the upper instrumentation piping 2a at a low-pressure side, a water-level measurement value varies, thereby making it difficult to measure an accurate water level. Further, when non-condensable gas is accumulated and retained in the instrumentation piping, steam inflow is disturbed. In view of this, there has been known such a technique to detect a temperature decrease caused due to this disturbance so as to estimate accumulation and retention of gas. However, this method is able to judge the accumulation and retention only after the temperature decreases sufficiently and thus has a large problem of delay in detection of the accumulation and retention.

Embodiments of the present invention have been achieved in order to solve the above problems, and intend to provide a water level measuring system which prevents non-condensable gas from being accumulated and retained in the water level measuring system and hereby is able to highly precisely measure a water level of a feed water heater and the like, and a non-condensable gas discharge device thereof.

### Means for Solving the Problems

In order to solve the problems, according to an embodiment, there is presented a water level measuring system for measuring a level of a water surface formed inside a plant device, the water level measuring system comprising: a riser piping section connected to the plant device at a position higher than the level of the water surface and extending to above the plant device; an upper piping section of which one end is connected to an upper end of the riser piping section; a connection piping section of which an upper end is connected to another end of the upper piping section opposite to a connecting part with the riser piping section and extending downward; a lower instrumentation piping of which one end is connected to the plant equipment at a position lower than the level of the water, surface; a water level gauge including a first connection section connected to the connection piping section and a second connection section connected to the lower instrumentation piping at a side opposite to a connecting part to the plant device, the water level gauge being for measuring a differential pressure between the first connection section and the second connection section; a vent pipe branching off from the connection piping section; a control valve provided in the vent device and discharging non-condensable gas in the connection piping section when the control valve is opened; and a hydrogen concentration detector mounted to at least one of the riser piping section, the upper piping section, and the connection piping section.

According to an embodiment, there is presented a non-condensable gas discharge device for a water level measuring system of a plant device, the water level measuring system comprising: an upper instrumentation piping including a riser piping section, an upper piping section, and a connection piping section; a lower instrumentation piping; a water level gauge connected to the upper instrumentation piping and the lower instrumentation piping; a vent pipe connected to the connection piping section and having a control valve; and a controller for controlling the control valve to be opened and closed, wherein a hydrogen concentration detector and a temperature sensor are provided in at least one of the riser piping section, the upper piping section, and the connection piping section, and the controller controls the control valve to be opened and closed based on detected values of the hydrogen concentration detector and the temperature sensor.

According to another embodiment, there is presented a non-condensable gas discharge device for a water level measuring system of a plant device, the water level measuring system comprising: an upper instrumentation piping including a riser piping section, an upper piping section, and a connection piping section; a lower instrumentation piping; a water level gauge connected to the upper instrumentation piping and the lower instrumentation piping; a vent pipe connected to the connection piping section and having a control valve; and a controller for controlling the control valve to be opened and closed, wherein a hydrogen concentration detector is provided in at least one of the riser piping section, the upper piping section, and the connection piping section, and the controller controls the control valve to be opened and closed based on a detected value of the hydrogen concentration detector.

### Advantageous Effect of the Invention

According to the present invention, it is possible to prevent non-condensable gas from being accumulated and retained in a water level measuring system and thereby to highly precisely measure a water level of a plant device such as a feed water heater and the like.

### BRIEF DESCRIPTION OF THE DRAWINGS

FIG. 1 is a configuration diagram of a water level measuring system according to a first embodiment.

FIG. 2 is a configuration diagram of a water level measuring system according to a second embodiment.

FIG. 3 is a configuration diagram of a conventional water level measuring system.

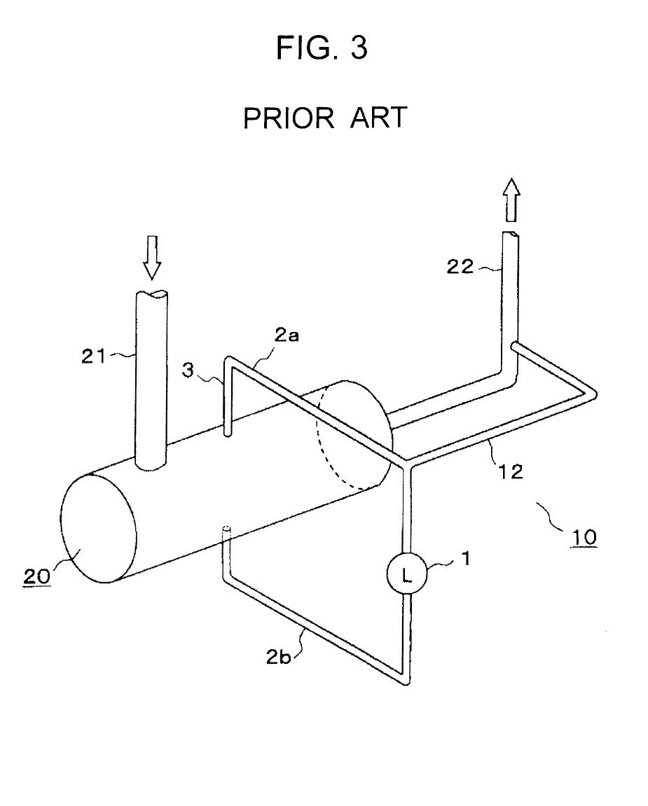

### EMBODIMENTS FOR CARRYING OUT THE INVENTION

Embodiments of a water level measuring system according to the present invention will be described below with reference to drawings. Note that each embodiment deals with an example in which a non-condensable gas discharge device is applied to a feed water heater, but this is not the only example, and it is needless to say that the non-condensable gas discharge device may be applied to other plant devices.

### First Embodiment

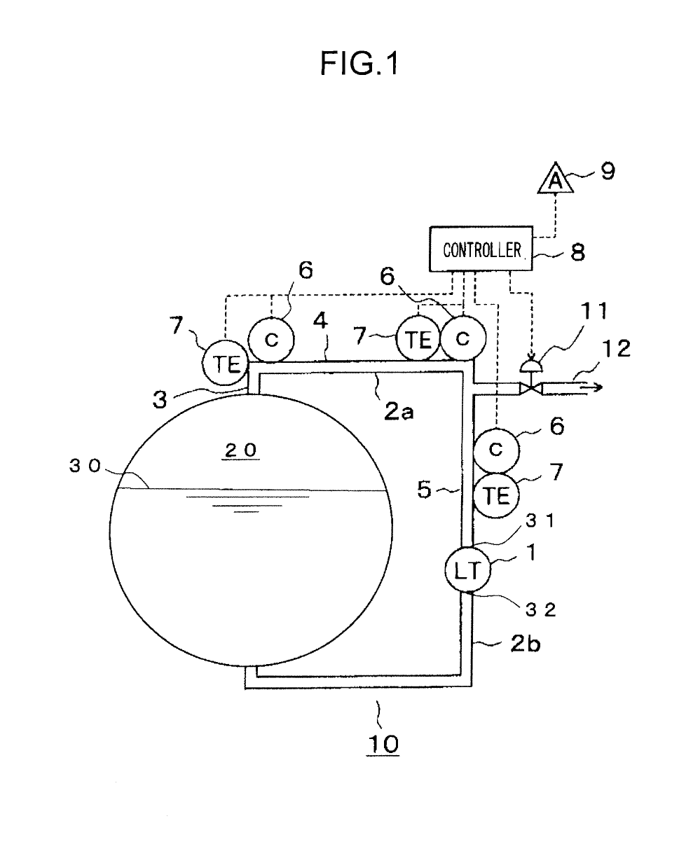

A water level measuring system according to a first embodiment is described with reference to FIG. 1.

(Configuration)

A water level measuring system 10 according to the first embodiment is constituted by an upper instrumentation piping 2a and a lower instrumentation piping 2b. One end of the upper instrumentation piping 2a is connected to an upper part of a feed water heater (plant device) 20 and another end of the upper instrumentation piping 2a is connected to a water level gauge 1. One end of the lower instrumentation piping 2b is connected to a bottom part of the feed water heater 20 and another end of the lower instrumentation piping 2b is connected to the water level gauge 1.

At the time of normal operation, a water surface 30 is formed within the feed water heater 20. The upper instrumentation piping 2a is connected to a gas phase part in the feed water heater 20, and the lower instrumentation piping 2b is connected to a liquid phase part in the feed water heater 20.

The upper instrumentation piping 2a is constituted by a riser piping section 3 which is a connecting part with the feed water heater 20, an upper piping section 4, and a connection piping section 5 which is connected to the water level gauge 1. A vent pipe 12 is connected to an upper part of the connection piping section 5 through a control valve 11.

The water level gauge 1 is provided with a first connection section 31 and a second connection section 32. The connection piping section 5 is connected to the first connection section 31, and the lower instrumentation piping 2b is connected to the second connection section 32. The water level gauge 1 detects a differential pressure between the first connection section 31 and the second connection section 32.

Each of the riser piping section 3, the upper piping section 4, and the connection piping section 5 of the upper instrumentation piping 2a is provided with a hydrogen concentration detector 6 and a temperature sensor 7, and signals from the hydrogen concentration detectors 6 and the temperature sensors 7 are input into a controller 8. Further, the controller 8 outputs a control signal to the control valve 11 of the vent pipe 12 and instructs an alarm device 9 to give or not give an alarm.

(Operation)

In the first embodiment thus configured, when any of the hydrogen concentration detectors 6 detects non-condensable gas including hydrogen as a main component and exceeding a predetermined reference value (a first hydrogen concentration limit value) in the upper instrumentation piping 2a, or when any of the temperature sensors 7 detects that a temperature decreasing due to disturbance to steam inflow because of accumulation of non-condensable gas in the upper instrumentation piping 2a exceeds a predetermined reference value (a first temperature limit value), the controller 8 controls the control valve 11 provided in the vent pipe 12 so as to be opened.

Further, when a detected value of the hydrogen concentration detector 6 exceeds a predetermined value (a second hydrogen concentration limit value) which is set in advance, or when a detected value of the temperature sensor 7 becomes lower than a predetermined value (a second temperature limit value) which is set in advance, the controller 8 instructs the alarm device 9 to give an alarm.

Note that the control valve 11 may be optionally able to be opened and closed by manual operation as needed. Further, in the present embodiment, each of the riser piping section 3, the upper piping section 4, and the connection piping section 5 is provided with the hydrogen concentration detector 6 and the temperature sensor 7, but the hydrogen concentration detector 6 and the temperature sensor 7 may not be provided in all of these sections and some of the hydrogen concentration detectors 6 and the temperature sensors 7 may be omitted.

Further, in the present embodiment, the vent pipe 12 is connected to an upper part of the connection piping section 5, but may be connected to the upper piping section 4.

(Effect)

According to this first embodiment, mainly at the time of starting of a nuclear power plant and at the time of load up, which easily cause retention and accumulation of non-condensable gas, non-condensable gas in instrumentation pipings of the water level measuring system in the feed water heater 20 is monitored by the hydrogen concentration detectors 6 and the temperature sensors 7, and when any of the detectors and sensors detects non-condensable gas of more than a reference value, the control valve 11 of the vent pipe 12 is opened. This makes it possible to discharge the non-condensable gas to the vent pipe 12 so as to minimize a measurement error of the water level gauge, thereby making it possible to increase reliability.

Further, the control valve 11 is closed at the time of normal operation, thereby making it possible to eliminate occurrence of sudden flow from the upper instrumentation piping 2a at a low-pressure side to the vent pipe 12, in which sudden flow might cause a variation in a measured value when a water level is measured by the differential-pressure water level gauge 1.

Further, by using an alarm monitor together, it is possible to surely confirm retention and accumulation of non-condensable gas. Further, in a case where the control valve 11 is in a closed state for some reason even when retention and accumulation of non-condensable gas is confirmed, it is possible to surely discharge the non-condensable gas to the vent pipe 12 by opening the control valve 11 by manual operation.

### Second Embodiment

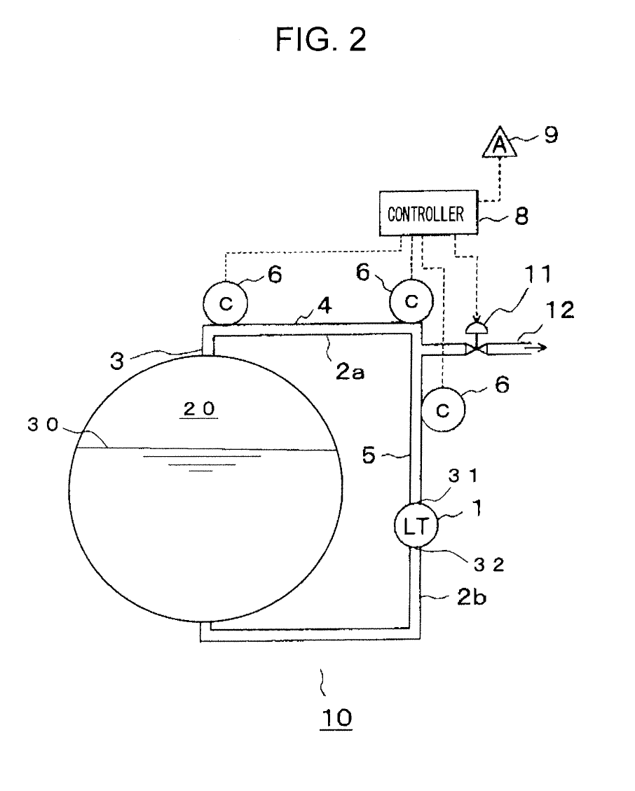

The following describes a non-condensable gas discharge device of a water level measuring system 10 according to a second embodiment with reference to FIG. 2. Note that the same constituent has the same reference numeral as in the above embodiment, and the same explanation is omitted.

The second embodiment has such a feature that detection of non-condensable gas is performed only by hydrogen concentration detectors 6.

In FIG. 2, the hydrogen concentration detector 6 is provided in any or all of the riser piping section 3, the upper piping section 4, and the connection piping section 5 of the upper instrumentation piping 2a.

In the second embodiment thus configured, when any one of the hydrogen concentration detectors 6 detects non-condensable gas including hydrogen as a main component and becoming a reference value or more in the water level measuring system, the controller 8 controls the control valve 11 provided in the vent pipe 12 so as to be opened.

Further, when a detected value of the hydrogen concentration detector 6 exceeds a predetermined value which is set in advance, the controller 8 instructs the alarm device 9 to give an alarm.

According to this second embodiment, it is possible to yield effects similar to the first embodiment, and in addition, since the detection of non-condensable gas is performed only by the hydrogen concentration detector 6, it is possible to reduce the number of devices and to reduce costs.

Some embodiments of the present invention have been described above, but these embodiments are merely described as examples and are not intended to limit a scope of the invention. These new embodiments can be performed in other various configurations, and various omissions, combinations, substitutions, and modifications can be performed without departing from the concept of the invention. These embodiments and the modifications thereof are included in the scope and the spirit of the invention, and are included within inventions described in claims and their equivalent ranges.

### DESCRIPTION OF REFERENCE NUMERALS

1 water level gauge, 2a upper instrumentation piping, 2b lower instrumentation piping, 3 riser piping section, 4 upper piping section, 5 connection piping section, 6 hydrogen concentration detector, 7 temperature sensor, 8 controller, 9 alarm device, 10 water level measuring system, 11 control valve, 12 vent pipe, 20 feed water heater (plant device), 30 water surface, 31 first connection section, 32 second connection section

1. A water level measuring system for measuring a level of a water surface formed inside a plant device, the water level measuring system comprising:
a riser piping section connected to the plant device at a position higher than the level of the water surface and extending to above the plant device;
an upper piping section of which one end is connected to an upper end of the riser piping section;
a connection piping section of which an upper end is connected to another end of the upper piping section opposite to a connecting part with the riser piping section and extending downward;
a lower instrumentation piping of which one end is connected to the plant equipment at a position lower than the level of the water surface;
a water level gauge including a first connection section connected to the connection piping section and a second connection section connected to the lower instrumentation piping at a side opposite to a connecting part to the plant device, the water level gauge being for measuring a differential pressure between the first connection section and the second connection section;
a vent pipe branching off from the connection piping section;
a control valve provided in the vent device and discharging non-condensable gas in the connection piping section when the control valve is opened; and
a hydrogen concentration detector mounted to at least one of the riser piping section, the upper piping section, and the connection piping section.

2. The water level measuring system according to claim 1, further comprising:
a controller for opening the control valve when a hydrogen concentration detected by the hydrogen concentration detector exceeds a predetermined first hydrogen concentration limit value.

3. The water level measuring system according to claim 1, further comprising:
an alarm device for giving an alarm when a hydrogen concentration detected by the hydrogen concentration detector exceeds a predetermined second hydrogen concentration limit value.

4. The water level measuring system according to claim 1, further comprising:
a temperature sensor mounted to at least one of the riser piping section, the upper piping section, and the connection piping section.

5. The water level measuring system according to claim 4, further comprising:
a controller for opening the control valve when a hydrogen concentration detected by the hydrogen concentration detector exceeds a predetermined first hydrogen concentration limit value or when a temperature detected by the temperature sensor becomes lower than a predetermined first temperature limit value.

6. The water level measuring system according to claim 4, further comprising:
an alarm device for giving an alarm when a hydrogen concentration detected by the hydrogen concentration detector exceeds a predetermined second hydrogen concentration limit value or when a temperature detected by the temperature sensor becomes lower than a predetermined second temperature limit value.

7. A non-condensable gas discharge device for a water level measuring system of a plant device, the water level measuring system comprising:
an upper instrumentation piping including a riser piping section, an upper piping section, and a connection piping section;
a lower instrumentation piping;
a water level gauge connected to the upper instrumentation piping and the lower instrumentation piping;
a vent pipe connected to the connection piping section and having a control valve; and
a controller for controlling the control valve to be opened and closed,
wherein a hydrogen concentration detector and a temperature sensor are provided in at least one of the riser piping section, the upper piping section, and the connection piping section, and the controller controls the control valve to be opened and closed based on detected values of the hydrogen concentration detector and the temperature sensor.

8. A non-condensable gas discharge device for a water level measuring system of a plant device, the water level measuring system comprising:
an upper instrumentation piping including a riser piping section, an upper piping section, and a connection piping section;
a lower instrumentation piping;
a water level gauge connected to the upper instrumentation piping and the lower instrumentation piping;
a vent pipe connected to the connection piping section and having a control valve; and
a controller for controlling the control valve to be opened and closed,
wherein a hydrogen concentration detector is provided in at least one of the riser piping section, the upper piping section, and the connection piping section, and the controller controls the control valve to be opened and closed based on a detected value of the hydrogen concentration detector.

9. The non-condensable gas discharge device for a water level measuring system according to claim 7, wherein:
when the detected value of the hydrogen concentration detector or the temperature sensor exceeds a predetermined value which is set in advance, the controller causes an alarm device to give an alarm.

10. The non-condensable gas discharge device for a water level measuring system according to claim 8, wherein:
when the detected value of the hydrogen concentration detector or the temperature sensor exceeds a predetermined value which is set in advance, the controller causes an alarm device to give an alarm.
